(19) United States
(12) Patent Application Publication
(10) Pub. No.: US 2016/0054968 A1
(43) Pub. Date: Feb. 25, 2016

(54) INFORMATION PROCESSING METHOD AND ELECTRONIC DEVICE

(71) Applicants: Beijing Lenovo Software Ltd., Beijing (CN); Lenovo (Beijing) Limited, Beijing (CN)

(72) Inventor: Xianfeng Cai, Beijing (CN)

(21) Appl. No.: 14/639,294

(22) Filed: Mar. 5, 2015

(30) Foreign Application Priority Data
Aug. 25, 2014 (CN) 201410422751.2

(51) Int. Cl. G06F 3/14; G06F 3/0481

(52) U.S. Cl. CPC G06F 3/1423; G06F 3/0481

(57) ABSTRACT

The present disclosure discloses an information processing method and an electronic device. The information processing method is applied in a first electronic device comprising a display unit capable of displaying at least one interactive object in a first category, wherein the interactive object in the first category can respond to a first category of operations, and the first electronic device can communicate with a second electronic device, the method comprising: acquiring a first interactive parameter; determining a type of the second electronic device according to the first interactive parameter; determining, according to the type of the second electronic device, a second interactive parameter matched with an interactive type corresponding to the second electronic device; and loading and displaying, according to the second interactive parameter, the interactive object in the first category.

### CROSS-REFERENCE TO RELATED APPLICATION(S)

This application claims priority to the Chinese Patent Application No. 201410422751.2, filed on Aug. 25, 2014, entitled “INFORMATION PROCESSING METHOD AND ELECTRONIC DEVICE”, which is incorporated herein by reference in its entirety.

### TECHNICAL FIELD

The present disclosure relates to the interactive technology in the field of communication, and in particular, to an information processing method and an electronic device.

### BACKGROUND

With development of electronic technologies, there are increasing modes of information interaction with an electronic device and types of interactive devices. The interactive devices may specifically be remote controls, wired mouses, wireless mouses, or any device on which an input mode, such as a gesture operation, a voice input, etc. can be implemented. Each of the interactive devices comprises a specific interactive mode and interactive features.

In the prior art, a controlled electronic device generally presents a same interactive interface no matter which interactive mode is used. This results in following problems.

The first problem is that: different interactive modes have different interactive features, and if a same interactive interface is used, it may result in poor user satisfaction. For example, when a remote control is used for control, since interaction with an interactive object is done by using keys of the remote control, the accuracy of control is high. Therefore, the interactive object may be made with a small size such that richer content can be displayed in the display area, without any impact to the interactive effects and the user satisfaction. However, when a gesture operation is used, if the interactive object is made with a relatively small size, it is pretty difficult for the user to select the interactive object. This will increase the difficulty in interaction, which in turn will obviously reduce the user satisfaction. Thus, the same interactive interface cannot achieve both of rich interactive content to be displayed and a good touch effect at the same time.

The second problem is that: in a case where the interactive device used by a user is unknown, in order to enable an interactive interface to support any interactive mode, when the interactive interface is loaded by the electronic device, all interactive response events of all interactive modes generally need to be loaded, which results in too many system resources being consumed when processes run in the background of the electronic device.

In summary, in order to improve user satisfaction for interaction with an electronic device, there is a need to address the above problems in the prior art.

### SUMMARY

In view of this, an embodiment of the present disclosure is expected to provide an information processing method and an electronic device, to load and display an interactive object in a first category according to a type of a second electronic device which interacts with a first electronic device, thereby improving user satisfaction and reducing system consumption.

In order to achieve the above purposes, the technical solutions of the present disclosure are achieved as follows.

An embodiment of the present disclosure provides an information processing method, the method comprising:

a first electronic device acquiring a first interactive parameter from a second electronic device;

the first electronic device determining a type of the second electronic device according to the first interactive parameter;

the first electronic device determining, according to the type of the second electronic device, a second interactive parameter corresponding to the second electronic device; and

the first electronic device displaying at least one interactive object, according to the second interactive parameter, via a display unit of the first electronic device.

According to an embodiment of the present disclosure, the second interactive parameter comprises a common interactive parameter and a characteristic interactive parameter, wherein the common interactive parameter is an interactive parameter commonly used in different interactive modes, and the characteristic interactive parameter is an interactive parameter solely used in respective interactive mode; and

the determining of a second interactive parameter according to the first interactive parameter comprises:

determining the characteristic interactive parameter in the second interactive parameter according to the first interactive parameter; whereas

the displaying of the interactive object according to the second interactive parameter comprises:

displaying the interactive object according to the characteristic interactive parameter.

According to an embodiment of the present disclosure, the characteristic interactive parameter comprises a display parameter; and

the displaying of the interactive object according to the second interactive parameter comprises:

displaying the interactive object according to the display parameter.

According to an embodiment of the present disclosure, the characteristic interactive parameter comprises a response parameter; and

the displaying of the interactive object, according to the second interactive parameter comprises:

loading a response event for the interactive object according to the response parameter.

According to an embodiment of the present disclosure, the first electronic device comprises at least two types of interactive interfaces, wherein each type of the interactive interfaces can be used to establish a connection with a corresponding type of second electronic devices; and

the acquiring of the first interactive parameter comprises:

detecting each type of the interactive interfaces to form a detection parameter; and

the determining of a type of the second electronic device according to the first interactive parameter comprises:

if the detection parameter indicates that only one type of the interactive interfaces has been used to establish a connection to the second electronic device, determining the type of the second electronic device according to the type of the interactive interface which has been used to establish a connection to the second electronic device.

According to an embodiment of the present disclosure, the determining of a type of the second electronic device according to the first interactive parameter further comprises:

determining the type of the second electronic device according to a selection strategy if the detection parameter indicates that at least two types of the interactive interfaces have been used to establish connections to the second electronic device.

According to an embodiment of the present disclosure, the first electronic device is further connected to a sensor unit;

the method further comprises:

displaying the interactive object corresponding to an autonomous interactive mode if the detection parameter indicates that none of the interactive interfaces is used to establish a connection to the second electronic device; and

detecting, by the first electronic device, an interactive operation input by a user through the sensor unit if the interactive object corresponding to the autonomous interactive mode is used.

According to an embodiment of the present disclosure, the first electronic device acquiring the first interactive parameter comprises:

the first electronic device receiving a first signal transmitted by the second electronic device; and

the first electronic device the determining the type of the second electronic device according to the first interactive parameter comprises:

determining the first interactive parameter according to the first signal.

According to an embodiment of the present disclosure, the display unit of the first electronic device is further configured to display an interactive object in different categories, wherein the interactive object in a particular category is used to respond to a corresponding category of operations; and

the first electronic device acquiring the first interactive parameter further comprises:

receiving a different category of operations input by a user through the interactive object in a different category; and

determining the first interactive parameter in response to the different category of operations.

An embodiment of the present disclosure provides an electronic device comprising a display unit capable of displaying at least one interactive object; and

a processor configured:

to acquire a first interactive parameter from a second electronic device;

to determine a type of the second electronic device according to the first interactive parameter;

to determine, according to the type of the second electronic device, a second interactive parameter corresponding to the second electronic device; and

to display the interactive object via the display unit.

According to an embodiment of the present disclosure, the second interactive parameter comprises a common interactive parameter and a characteristic interactive parameter, wherein the common interactive parameter is an interactive parameter commonly used in different interactive modes, and the characteristic interactive parameter is an interactive parameter solely used in respective interactive mode; and

the processor is configured:

to determine the characteristic interactive parameter in the second interactive parameter according to the first interactive parameter; and

to display the interactive object according to the characteristic interactive parameter.

According to an embodiment of the present disclosure, the characteristic interactive parameter comprises a display parameter; and

the display unit is further configured to display the interactive object according to the display parameter.

According to an embodiment of the present disclosure, the characteristic interactive parameter comprises a response parameter; and

the processor is further configured to load response events for the interactive object according to the response parameter.

According to an embodiment of the present disclosure, the first electronic device comprises at least two types of interactive interfaces, wherein each type of interactive interfaces can be used to establish a connection to a corresponding type of second electronic devices; and

the processor is further configured:

to detect each type of the interactive interfaces to form a detection parameter; and

to determine whether a connection is established between the first electronic device and the second electronic device according to the detection parameter, and configured to, if the detection parameter indicates that only one type of interactive interface has been used to establish a connection to the second electronic device, determine the type of the second electronic device according to a type of the interactive interface which has been used to establish a connection to the second electronic device.

According to an embodiment of the present disclosure, the processor is further configured to determine the type of the second electronic device according to a selection strategy when the detection parameter indicates that at least two types of interactive interfaces are used to establish connections to the second electronic device.

According to an embodiment of the present disclosure, the first electronic device is further connected to a sensor unit;

the processor is configured to display the interactive object corresponding to an autonomous interactive mode if the detection parameter indicates that none of the interactive interfaces is used to establish a connection to the second electronic device; and

the sensor unit is configured to detect an interactive operation input by a user if the interactive object corresponding to the autonomous interactive mode is used.

According to an embodiment of the present disclosure, the processor is further configured:

to receive a first signal transmitted by the second electronic device; and

to determine the first interactive parameter according to the first signal.

According to an embodiment of the present disclosure, the display unit is further configured to display an interactive object in different categories, wherein the interactive object in a different category is used to respond to a different category of operations; and

the processor is further configured to receive a different category of operations input by a user through a different category of interactive operations; and to determine the first interactive parameter in response to the different category of operations.

With the information processing method and electronic device according to the embodiments of the present disclosure, the type of the second electronic device is determined by acquiring the first interactive parameter, and the second interactive parameter is determined according to the type of the second electronic device; and therefore the interactive object in the first category can be loaded and displayed according to the features of interactive modes in which different types of second electronic devices interact with the first electronic device. With respect to the second electronic device, such as a remote control which achieves accurate control by using direction keys, an area of the interactive object in the first category can be suitably reduced so that richer information can be displayed; and with respect to the second electronic device such as a wireless mouse, the area of the interactive object in the first category can be suitably increased and response events specific to the wireless mouse can be loaded, so that user operation is facilitated. Obviously, the user satisfaction can be improved, and an amount of data to be loaded by the first electronic device can be reduced.

### BRIEF DESCRIPTION OF THE DRAWINGS

FIG. 1 is a first structural diagram of a first electronic device according to an embodiment of the present disclosure;

FIG. 2 is a flowchart of an information processing method according to an embodiment of the present disclosure;

FIG. 3a is a first diagram of display of the interactive object in the first category according to an embodiment of the present disclosure;

FIG. 3b is a second diagram of display of the interactive object in the first category according to an embodiment of the present disclosure;

FIG. 4 is a first flowchart of acquiring a first interactive parameter according to an embodiment of the present disclosure;

FIG. 5 is a second structural diagram of the first electronic device according to an embodiment of the present disclosure;

FIG. 6 is a third structural diagram of the first electronic device according to an embodiment of the present disclosure; and

FIG. 7 is a diagram of display of an interactive object in a second category according to an embodiment of the present disclosure.

### DETAILED DESCRIPTION

The technical solutions of the present disclosure will be further described in detail below in conjunction with description drawings and specific embodiments.

### First Method Embodiment

As shown in FIG. 1, the present embodiment provides an information processing method applied in a first electronic device comprising a display unit 150 capable of displaying at least one interactive object in a first category, wherein the interactive object in the first category can respond to a first category of operations, and the first electronic device can communicate with a second electronic device. The interactive object in the first category may specifically comprise for example, a video player application icon 101, a dialog box 102 including determination and deletion controls or the like.

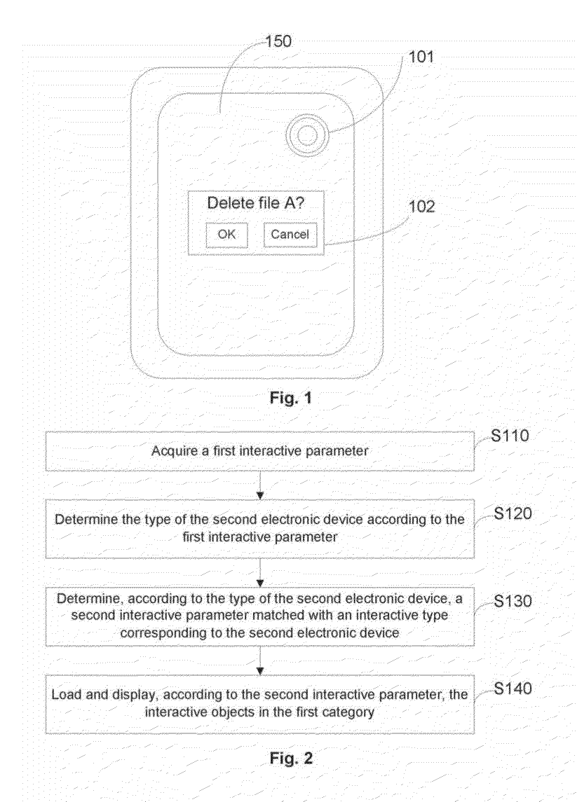

As shown in FIG. 2, the method comprises the following steps.

In step S110, a first interactive parameter is acquired;

in step S120, a type of the second electronic device is determined according to the first interactive parameter;

in step S130, a second interactive parameter matched with an interactive type corresponding to the second electronic device is determined according to the type of the second electronic device; and

in step S140, the interactive object in the first category is loaded and displayed according to the second interactive parameter.

The first electronic device may be a television, a personal PC computer, a tablet computer, or a large display screen or the like. The second electronic device is an electronic device which can communicate with the first electronic device, and preferably, an electronic device which can transmit a control signal to the first electronic device. The second electronic device may be a terminal device such as a wireless mouse (for example, an air mouse), a wired mouse, a remote control and/or a smart phone or the like, and preferably, a wireless terminal device.

Both of the first interactive parameter and the second interactive parameter are interaction related parameters. In the present embodiment, the acquiring of a first interactive parameter may further comprise receiving the first interactive parameter transmitted by the second electronic device, or extracting the first interactive parameter from information transmitted by the second electronic device, or detecting, by a detection unit, an interactive interface to acquire the interactive parameter.

The interactive object in the first category is an interactive object which performs corresponding response operations in response to receiving an input from the second electronic device, for example, controls displayed in the display unit which perform operations such as deletion, determination, open, close, zoom in, zoom out, scroll or shift or the like.

Response events for the interactive object in the first category may be different for different types of second electronic devices, and the different types of second electronic devices may correspond to different operation features. Specifically, for example, a remote control is used to control the first electronic device using numeric buttons and direction keys. Obviously, the remote control may be used to accurately control the first electronic device using numeric buttons and direction keys. Therefore, the interactive object in the first category displayed by the first electronic device only need to occupy a display area on which content can be clearly presented to the user for view. In addition, the required response events for the interactive object in the first category are relatively simple. As another example, a wireless mouse is used to aim at the first category interactive objects through movement of the wireless mouse, and the interactive object in the first category is selected by performing a click action with the mouse. The wireless mouse may rotate or rapidly swipe. Obviously, the interactive object in the first category needs to respond with different events for different operations of the wireless mouse and the remote control. In order to facilitate the wireless mouse in aiming at the interactive object in the first category, the interactive object in the first category cannot be made too small; otherwise, a problem that it is difficult to operate may occur.

Therefore, in the present embodiment, the type of the second electronic device is firstly determined according to the first interactive parameter, and in step S130, a second interactive parameter matched with the second electronic device is determined according to the type of the second electronic device.

In the present embodiment, different interactive objects are selected, loaded and displayed according to different types of second electronic devices, and the interactive object in the first category may be adjusted according to each type of second electronic device, thereby a good tradeoff between the amount of information in the interactive interface and convenience of the operation or the like can be achieved, and a high user satisfaction can be achieved as well. Obviously, as it has currently been determined which type of second electronic device is used to interact with the first electronic device, the first electronic device only needs to load and display the corresponding interactive objects in the first category, which can reduce the amount of runtime loaded data for the first electronic device and reduce system consumption.

### Second Method Embodiment

The present embodiment provides an information processing method applied in a first electronic device comprising a display unit capable of displaying at least one interactive object in a first category, wherein the interactive object in the first category can respond to a first category of operations, and the first electronic device can communicate with a second electronic device.

As shown in FIG. 2, the method comprises the following steps.

In step S110, a first interactive parameter is acquired;

in step S120, a type of the second electronic device is determined according to the first interactive parameter;

in step S130, a second interactive parameter matched with an interactive type corresponding to the second electronic device is determined according to the type of the second electronic device; and

in step S140, the interactive object in the first category is loaded and displayed according to the second interactive parameter.

The second interactive parameter comprises a common interactive parameter and a characteristic interactive parameter, wherein the common interactive parameter is an interactive parameter commonly used in different interactive modes, and the characteristic interactive parameter is an interactive parameter solely used in respective interactive mode;

step S130 comprises:

the characteristic interactive parameter in the second interactive parameter is determined according to the first interactive parameter; and

step S140 comprises:

the interactive object in the first category is loaded according to the characteristic interactive parameter.

Specifically, when a video is played by the first electronic device, controls such as a fast forward control, a stop control, and a start control or the like will generally be displayed, and these controls constitute the interactive objects in the first category. In general, an interactive interface may be comprised of multiple interactive objects in the same display page, and the interactive interface may be considered as the interactive object in the first category having the same area as that of the display page.

Generally, no matter which type of second electronic device is used to control the first electronic device to display the video, a start control, a stop control and a fast forward control or the like may be included.

Assume that when direction keys of a remote control are used for control, a display area corresponding to the above controls is a first area, and when a wireless mouse is used for control, a display area corresponding to the above controls is a second area. Generally, the first area is smaller than the second area. However, an icon pattern, a color of the icon, or texts in the icon corresponding to the control may be maintained unchanged.

Obviously, although the first electronic device is controlled by using different types of second electronic devices and the second category of parameters which are used for loading and displaying the first category of interactive objects may be different, a part of the second interactive parameters may also be common.

In order to reduce the amount of data of parameters stored in the first electronic device and reduce the amount of data to be processed when the interactive object in the first category is loaded, in the present embodiment, the second interactive parameter comprises a common interactive parameter and a characteristic interactive parameter.

Obviously, step S130 further comprises determining the characteristic interactive parameter corresponding to the second electronic device according to the type of the second electronic device; and step S140 further comprises loading and displaying the interactive object in the first category according to the common interactive parameter and the determined characteristic interactive parameter.

With this method, a speed at which the interactive object in the first category is loaded and displayed can further be improved. Specifically, when the type of the second electronic device has not been determined, the first electronic device may pre-read the common interactive parameter, and pre-load a part of common interactive objects which are commonly used, in this case, once the type of the second electronic device is determined, it only needs to directly read and operate a corresponding characteristic interactive parameter, thereby enhancing a loading speed.

As another example, switching is performed from interactive object in a first category corresponding to a first type of second electronic device to an interactive object in a second category corresponding to a second type of second electronic device. In this case, the first electronic device may need to read a characteristic interactive parameter corresponding to the second type of second electronic device to overwrite a characteristic interactive parameter corresponding to the first type of second electronic device, without re-loading and displaying all second interactive parameters. Obviously, the amount of data to be processed by the first electronic device is reduced, and the loading speed is increased.

For the interactive interface, no matter which interactive mode is used, the interactive interface may have general layout parameters without too many changes. Those which are maintained unchanged correspond to the common interactive parameter.

On the basis of the above embodiment, the present embodiment further defines how to load the interactive object in the first category according to the type of the second electronic device. Not only the interactive object in the first category can be provided, loaded and displayed for each type of second electronic device, but also the amount of data to be stored and processed by the first electronic device can be reduced by distinguishing the common interactive parameter of the second electronic device from the characteristic interactive parameter.

### Third Method Embodiment

The present embodiment provides an information processing method applied in a first electronic device comprising a display unit capable of displaying at least one interactive object in a first category, wherein the interactive object in the first category can respond to a first category of operations, and the first electronic device can communicate with a second electronic device.

As shown in FIG. 2, the method comprises the following steps.

In step S110, a first interactive parameter is acquired;

in step S120, a type of the second electronic device is determined according to the first interactive parameter;

in step S130, a second interactive parameter matched with an interactive type corresponding to the second electronic device is determined according to the type of the second electronic device; and

in step S140, the interactive object in the first category is loaded and displayed according to the second interactive parameter.

The characteristic interactive parameter comprises a display parameter; and

step S130 comprises:

the interactive object in the first category is displayed according to the display parameter.

If the interactive object in the first category corresponds to an icon, a display parameter of the icon comprises a location parameter, an area parameter, a text style, and a color parameter, or the like.

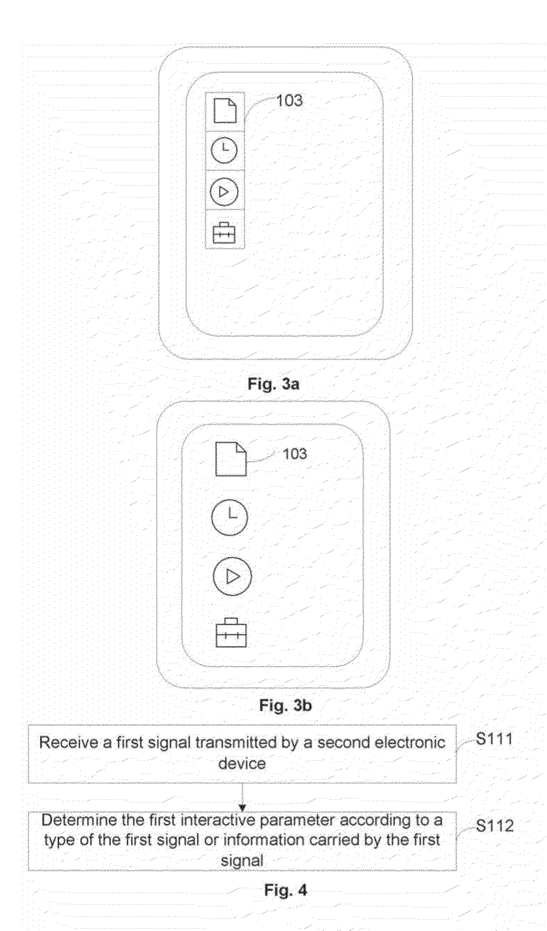

Interactive objects in a first category corresponding to a remote control are displayed in FIG. 3a, and interactive objects in the first category corresponding to a wireless mouse are displayed in FIG. 3b. It can be seen from FIGS. 3a-3b that according to the characteristics of accurate control by the remote control and the characteristics of manual control of the wireless mouse for aiming at the interactive objects in the first category, display areas of the interactive objects in the first category 103 in FIG. 3a are smaller than display areas of the same interactive objects in the first category 103 in FIG. 3b. In addition, in FIG. 3a, the interactive objects in the first category 103 with different functions are provided consecutively based on the control communication from the remote control with the direction keys, while in FIG. 3b, the interactive objects in the first category with different functions are provided separately, for ease of aiming of the wireless mouse. Obviously, the layout of the interactive objects in the first category in FIG. 3a is relatively compact, and the layout of the interactive objects in the first category in FIG. 3b is relatively incompact. More and richer content may be displayed in FIG. 3a than in FIG. 3b.

On the basis of any of the above embodiments, the information processing method according to the present embodiment further defines that the characteristic interactive parameter comprises a display parameter, and the interactive object in the first category is displayed differently according to interactive features of different types of second electronic devices, so as to improve the user satisfaction.

### Fourth Method Embodiment

The present embodiment provides an information processing method applied in a first electronic device comprising a display unit capable of displaying at least interactive object in a first category, wherein the interactive object in the first category can respond to a first category of operations, and the first electronic device can communicate with a second electronic device.

As shown in FIG. 2, the method comprises the following steps.

In step S110, a first interactive parameter is acquired;

in step S120, a type of the second electronic device is determined according to the first interactive parameter;

in step S130, a second interactive parameter matched with an interactive type corresponding to the second electronic device is determined according to the type of the second electronic device; and

in step S140, the interactive object in the first category is loaded and displayed according to the second interactive parameter.

The second interactive parameter comprises a common interactive parameter and a characteristic interactive parameter, wherein the common interactive parameter is an interactive parameter commonly used in different interactive modes, and the characteristic interactive parameter is an interactive parameter solely used in respective interactive mode;

Step S130 comprises:

the characteristic interactive parameter in the second interactive parameter is determined according to the first interactive parameter; and

step S140 comprises:

the interactive object in the first category is loaded according to the characteristic interactive parameter.

The characteristic interactive parameter comprises a response parameter; and

step S140 may further comprise:

response events for the interactive object in the first category are loaded according to the response parameter.

Specifically, a dialog box or a webpage window displayed on the display unit may be dragged by a mouse. Obviously, this is difficult to be achieved by only using a remote control including numeric keys and/or direction keys. Obviously, if it needs to respond to a mouse drag event, a response event corresponding to mouse drag must be loaded in the background of the first electronic device; otherwise, the dialog box or webpage window cannot be dragged.

As another example, a wireless mouse can generally move on a supporting plane. However, if the wireless mouse is hold by a user, the user may control the wireless mouse to swipe, circle, or perform another particular operation in a vertical plane. These operations may correspond to different response events.

Of course, in a specific implementation, when the interactive object in the first category is loaded, response events for the interactive object in the first category may further need to be loaded according to the common interactive parameter.

Therefore, the characteristic interactive parameter further comprises a response parameter. Different response parameters may be loaded according to features of interactive modes corresponding to different types of second electronic devices. Obviously, compared with loading response parameters of all second electronic devices which can be supported in the prior art, the number of parameters to be loaded in the background, an amount of information to be maintained, and system consumption and busyness are reduced.

In a specific implementation, the characteristic interactive parameter may further comprise the display parameter and the response parameter at the same time. Then, step S140 may further comprise displaying the interactive object in the first category according to the display parameter, and loading the response events of the interactive object in the first category according to the response parameter.

On basis of any of the above embodiments, the method according to the present embodiment further defines that response events for the interactive object in the first category are loaded differently according to the type of the second electronic device, thereby reducing the system consumption of the first electronic device.

### Fifth Method Embodiment

The present embodiment provides an information processing method applied in a first electronic device comprising a display unit capable of displaying at least one interactive object in a first category, wherein the interactive object in the first category can respond to a first category of operations, and the first electronic device can communicate with a second electronic device.

As shown in FIG. 2, the method comprises the following steps.

In step S110, a first interactive parameter is acquired;

in step S120, a type of the second electronic device is determined according to the first interactive parameter;

in step S130, a second interactive parameter matched with an interactive type corresponding to the second electronic device is determined according to the type of the second electronic device; and

in step S140, the interactive object in the first category is loaded and displayed according to the second interactive parameter.

The first electronic device comprises at least two interactive interfaces, wherein one interactive interface can be used to establish a connection to the second electronic device;

step S110 comprises:

each interactive interface is detected to form a detection parameter; and

step S120 comprises:

when the detection parameter indicates that only one interactive interface has been used to establish a connection to the second electronic device, the type of the second electronic device is determined according to the type of the interactive interface which has been used to establish a connection to the second electronic device.

The interactive interface may be a wired interactive interface (such as a USB interface), a Bluetooth interactive interface, an infrared interactive interface, and another type of near-field communication interactive interface or the like.

Different types of second electronic devices will establish a connection to the first electronic device through different interactive interfaces. Specifically, for example, a remote control generally establishes a connection to the first electronic device through an infrared interactive interface, a wired mouse generally establishes a connection to the first electronic device through a wired interface such as USB or the like, and a wireless mouse generally establishes a connection to the first electronic device through a Bluetooth interactive interface.

Therefore, in the present embodiment, the first electronic device is configured to detect each type of interactive interface, to form a detection parameter. Specifically, for example, if a wired mouse establishes a connection to the first electronic device, an electric connection link has been formed on a corresponding wired interface, and an interactive signal is transmitted in the electric connection link, or the level of an enabled terminal of a corresponding pin has changed. As another example, if a wireless mouse establishes a connection to the first electronic device through a Bluetooth interactive interface, the first electronic device may have been started a Bluetooth connection, and a corresponding Bluetooth transmission signal or Bluetooth transmission start signal or the like may be detected on the Bluetooth interactive interface. Therefore, the interactive interface may be detected to determine whether a second electronic device establishes a connection to the first electronic device through the interactive interface.

In a specific implementation, if the second electronic device establishes a connection to the first electronic device, information representing that a connection has been established (specifically, a connection flag bit for example) will generally be formed in a storage medium of the interactive interface of the first electronic device. Obviously, the interactive interface may be detected to extract the information, and then it is determined whether a connection has been established between the second electronic device and the first electronic device according to the information.

In the present embodiment, the type of the second electronic device is determined according to the type of the interactive interface, which has an advantage that it is simple and convenient to implement. In the present embodiment, it is further specified that when only one interactive interface is used to establish a connection to the second electronic device, the type of the second electronic device may be directly determined according to the type of the interactive interface.

### Sixth Method Embodiment

The present embodiment provides an information processing method applied in a first electronic device comprising a display unit capable of displaying at least one interactive object in a first category, wherein the interactive object in the first category can respond to a first category of operations, and the first electronic device can communicate with a second electronic device.

As shown in FIG. 2, the method comprises the following steps.

In step S110, a first interactive parameter is acquired;

in step S120, a type of the second electronic device is determined according to the first interactive parameter;

in step S130, a second interactive parameter matched with an interactive type corresponding to the second electronic device is determined according to the type of the second electronic device; and

in step S140, the interactive object in the first category is loaded and displayed according to the second interactive parameter.

The first electronic device comprises at least two interactive interfaces, wherein one interactive interface can be used to establish a connection to the second electronic device;

step S110 comprises:

each interactive interface is detected to form a detection parameter; and

step S120 comprises:

when the detection parameter indicates that only one interactive interface has been used to establish a connection to the second electronic device, the type of the second electronic device is determined according to the type of the interactive interface which has been used to establish a connection to the second electronic device.

When the detection parameter indicates that at least two interactive interfaces have been used to establish a connection to the second electronic device, the type of the second electronic device is determined according to a selection strategy.

The determining of the type of the second electronic device according to a selection strategy may further comprise at least one of the following manners.

In a first manner, the type of the second electronic device is determined according to usage records. Specifically, when two types of second electronic devices are connected to the first electronic device, usage frequencies of respective second electronic devices in a recent period of time are determined according to the usage records, and a second electronic device with a highest usage frequency is selected from the second electronic devices which have established a connection to the first electronic device, as a device which interacts with the first electronic device for this time. In this way, the type of the second electronic device can be directly determined. Specifically, a remote control, a wireless mouse, and a wired mouse are currently connected to the first electronic device, it finds that the wireless mouse is frequently used by a user in a recent week to interact with the first electronic device, and the wireless mouse has a highest usage frequency. In this case, the type of the second electronic device which interacts with the first electronic device for this time is determined to be the wireless mouse. The recent period of time may specifically be a specified time, such as 2 weeks or 1 month or the like.

As another example, a second electronic device which interacts with the first electronic device for the last time from the second electronic devices which have established a connection to the first electronic device is determined as a device which interacts with the first electronic device for this time. For example, the current time is 10:00, and it can be determined from the usage records that the time when the wireless mouse interacts with the first electronic device for the last time is 18:26 yesterday, the time when the wired mouse interacts with the first electronic device for the last time is 23:50 yesterday, and the time when the remote control interacts with the first electronic device for the last time is 9:00 today. According to the usage records, it is highly possible that only the remote control is currently at hand for the user or the user just wants to use the remote control. Therefore, the type of the second electronic device is determined to be the remote control in combination with the detection parameter and the usage records.

In a second manner, the type of the second electronic device is determined based on the user information and the detection parameter.

User information is recorded in the first electronic device, such as a user's age, second electronic devices commonly-used by the user. When many types of second electronic devices have established connections to the first electronic device, the type of the second electronic device which interacts with the first electronic device for this time can be determined according to the user information, thereby facilitating in subsequent loading and displaying of the interactive object in the first category matched with the type of the second electronic device.

For example, when a user is currently at the age of 60, the old person is usually not good at using a mouse. In this case, a remote control may preferably be used as the type of the second electronic device which interacts with the first electronic device for this time.

In a third manner, when it is detected according to the detection parameter that many types of interactive interfaces have been connected to the second electronic device, a user may be prompted by displaying a dialog box to select a second electronic device therefrom, and the type of the second electronic device is determined based on the user selection. Specifically, if a user picks up a remote control and performs a key press operation, it obviously represents that the user has selected the remote control as the second electronic device which interacts with the first electronic device for this time, and then the type of the second electronic device is determined to be a remote control; and if a user picks up a wireless mouse and operates on any control of the wireless mouse to input information into the first electronic device through the wireless mouse, the second electronic device which interacts with the first electronic device for this time can be determined to be a wireless mouse.

In conclusion, the present embodiment specifically defines how to specifically determine the type of the second electronic device which interacts with the first electronic device for this time when the first electronic device is connected to many types of second electronic devices, which has advantages that it is simple to implement and different user requirements can be intelligently satisfied.

### Seventh Method Embodiment

The present embodiment provides an information processing method applied in a first electronic device comprising a display unit capable of displaying at least one interactive object in a first category, wherein the interactive object in the first category can respond to a first category of operations, and the first electronic device can communicate with a second electronic device.

As shown in FIG. 2, the method comprises the following steps.

In step S110, a first interactive parameter is acquired;

in step S120, a type of the second electronic device is determined according to the first interactive parameter;

in step S130, a second interactive parameter matched with an interactive type corresponding to the second electronic device is determined according to the type of the second electronic device, and

in step S140, the interactive object in the first category is loaded and displayed according to the second interactive parameter.

The first electronic device comprises at least two interactive interfaces, wherein one interactive interface can be used to establish a connection to the second electronic device;

step S110 comprises:

each interactive interface is detected to form a detection parameter;

the first electronic device is further connected to a sensor unit;

the method further comprises:

when the detection parameter indicates that none of the interactive interfaces is used to establish a connection to the second electronic device, the interactive object in the first category corresponding to an autonomous interactive mode is loaded and displayed; and

when the interactive object in the first category corresponding to the autonomous interactive mode is used, an interactive operation input by a user through the sensor unit is detected by the first electronic device.

The sensor unit may be directly located in the first electronic device, and is a component of the first electronic device; or may also be a structure connected to the first electronic device.

The autonomous interactive mode may be voice interaction, hover touch, and/or eye tracking or the like. The hover touch is an operation instruction input by a user to the first electronic device through a gesture.

Specifically, the sensor unit may be a voice collection and analysis unit to collect a user's voice and control an operation of the first electronic device according to the voice. The voice collection and analysis unit may be a structure such as a microphone integrated in the first electronic device and a database of a voice recognition model or the like, or may also be a structure such as a microphone connected through a peripheral interface such as USB or the like. In a specific process, the sensor unit may also be a structure such as a camera capable of collecting a user's gesture or the like. The sensor unit is a high precision capacitive sensor capable of implementing hover touch. The sensor unit may have different specific structures according to different autonomous interactive modes, and will not be described in detail here.

In the present embodiment, when no second electronic device is connected to an interactive interface of the first electronic device, a user's instruction is received in the autonomous interactive mode, and when an interactive object in a first category is loaded and displayed, the interactive object in the first category corresponding to the autonomous interactive mode is loaded and displayed. In a specific implementation, the autonomous interactive mode may also be selected directly according to the users instruction, thereby loading the interactive object in the first category corresponding to the autonomous interactive mode.

### Eighth Method Embodiment

The present embodiment provides an information processing method applied in a first electronic device comprising a display unit capable of displaying at least one interactive object in a first category, wherein the interactive object in the first category can respond to a first category of operations, and the first electronic device can communicate with a second electronic device.

As shown in FIG. 2, the method comprises the following steps.

In step S110, a first interactive parameter is acquired;

in step S120, a type of the second electronic device is determined according to the first interactive parameter;

in step S130, a second interactive parameter matched with an interactive type corresponding to the second electronic device is determined according to the type of the second electronic device; and

in step S140, the interactive object in the first category is loaded and displayed according to the second interactive parameter.

As shown in FIG. 4, step S110 comprises the following steps.

In step S111, a first signal transmitted by the second electronic device is received; and

in step S112, the first interactive parameter is determined according to the type of the first signal or information carried by the first signal.

The type of the first signal may be identified according to an attribute of the signal, for example, whether the signal is a wired signal or a wireless signal, whether the wireless signal is an infrared signal, a Bluetooth signal, or another radio frequency signal, or the like.

The type of the first signal may also depend on a communication protocol to follow. For example, if the current signal is transmitted according to a Bluetooth communication protocol, the current signal corresponds to a Bluetooth signal.

Therefore, in the present embodiment, the first interactive parameter may be determined according to the type of the signal, and is then used to determine the type of the second electronic device.

Obviously, information may also be carried by the first signal, and the first interactive parameter is determined according to the information carried by the first signal. Specifically, for example, a data packet is transmitted by the second electronic device to the first electronic device, and a corresponding sequence is carried by a specified field of the data packet. Different sequences correspond to different types of second electronic devices. Specifically, for example, the specified field comprises 3 bits, and a mapping relationship is shown in the following table.

| Sequence | Second electronic device |
|---|---|
| 000 | Infrared remote control |
| 001 | Wireless mouse |
| 010 | Wired mouse |
| 011 | Voice input |
| 100 | Hover touch |
| 101 | Smart phone |
| 110 | Wireless keyboard |

When a sequence “000” is stored in the specified field of the first signal, the first interactive parameter is 000; and the type of the second electronic device is determined to be an infrared remote control according to the first interactive parameter.

In a specific implementation, the second electronic device which transmits the first signal specifies itself as a device which interacts with the first electronic device for this time, and then the first signal including a corresponding sequence may be automatically transmitted by the second electronic device to the first electronic device in the specified field according to a previous agreement. Alternatively, the second electronic device may also indicate that another second electronic device interacts with the first electronic device for this time through the specified field. Specifically, it only needs to load a sequence corresponding to another second electronic device in the specified field of the first signal.

Specifically, a smart phone is used to specify that the first electronic device is controlled by using a wireless mouse. In this case, a sequence “001” may be added in the specified field of the first signal transmitted by the smart phone to the first electronic device. The second electronic device may be connected to the first electronic device in a communication manner such as Wi-Fi or Bluetooth, or the like. The smart phone may be used to directly control the first electronic device. However, the smart phone is generally a device which has higher consumption than a second electronic device of a type such as a remote control, a wireless mouse or the like. Therefore, in order to save the power consumption of the smart phone, the smart phone may be used to only perform some complex operations. In an example, the smart phone may be used to specify the type of the second electronic device, and to input keywords for searching for a video. Specifically, when the first electronic device is a smart television, if keywords for searching for a webpage are input through a remote control, it is obviously inconvenient. In this case, the input operation may be performed by the smart phone. Obviously, when a webpage is searched, the smart phone may also indicate that a wireless keyboard is used to input search keywords into the first electronic device.

Then in step S140, the second interactive parameter is determined according to the type of the second electronic device and is then used to load and display the interactive object in the first category, so as to satisfy different user requirements for interaction, thereby improving the user satisfaction.

### Ninth Method Embodiment

The present embodiment provides an information processing method applied in a first electronic device comprising a display unit capable of displaying at least one interactive object in a first category, wherein the interactive object in the first category can respond to a first category of operations, and the first electronic device can communicate with a second electronic device.

As shown in FIG. 2, the method comprises the following steps.

In step S110, a first interactive parameter is acquired;

in step S120, a type of the second electronic device is determined according to the first interactive parameter;

in step S130, a second interactive parameter matched with an interactive type corresponding to the second electronic device is determined according to the type of the second electronic device; and

in step S140, the interactive object in the first category is loaded and displayed according to the second interactive parameter.

The display unit is further configured to display an interactive object in a second category, wherein the interactive object in the second category is used to respond to a second category of operations, and the second category of operations are switching operations between the interactive modes;

step S110 further comprises:

the second category of operations input by a user are received through the interactive object in the second category; and

the first interactive parameter is determined in response to the second category of operations.

In the present embodiment, the interactive object in the second category for switching between the interactive modes may be displayed by the display unit in an edge position thereof, thereby facilitating the user in switching between different interactive modes.

Specifically, the interactive object in the second category may always be displayed in the specified position in a hover manner; or when it is detected that a cursor of a mouse approaches the specified position, the interactive object in the second category is switched from a hidden state to a displayed state for display.

In conclusion, in the present embodiment, the interactive object in the second category is set on the display unit to facilitate a user in switching from one interactive mode to another interactive mode, thereby improving intelligence of the electronic device and users' satisfaction.

### First Device Embodiment

As shown in FIG. 1, the present embodiment provides an electronic device comprising a display unit 150 capable of displaying at least one interactive object in a first category, wherein the electronic device is a first electronic device, the interactive object in the first category can respond to a first category of operations, and the first electronic device can communicate with a second electronic device. An interactive object of the first category 101 and an interactive object of the first category 102 are shown in FIG. 1.

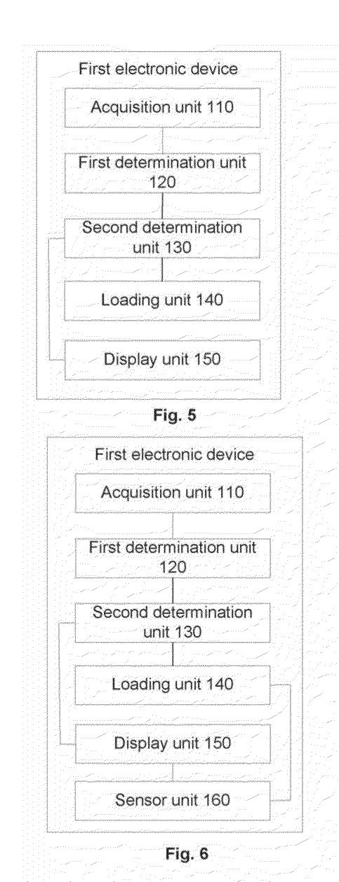

As shown in FIG. 5, the first electronic device comprises:

an acquisition unit 110 configured to acquire a first interactive parameter;

a first determination unit 120 configured to determine a type of the second electronic device according to the first interactive parameter;

a second determination unit 130 configured to determine, according to the type of the second electronic device, a second interactive parameter matched with an interactive type corresponding to the second electronic device;

a loading unit 140 configured to load, according to the second interactive parameter, the interactive object in the first category; and

the display unit 150 further configured to display the interactive object in the first category. It should be appreciated that the acquisition unit 110, the first determination unit 120, the second determination unit 130 and the loading unit 140 may be comprised in one or more processors of the first electronic device.

The first electronic device may be a television, a projector, a computer screen, and/or a tablet computer, or the like. The second electronic device may be an electronic device for inputting control information to the first electronic device such as a remote control, a wired mouse, a wireless mouse, or a smart phone, or the like.

The acquisition unit 110 may have different structures according to different manners for acquiring the first interactive parameter. When the first interactive parameter is received from the second electronic device, a specific structure of the acquisition unit 110 may be a communication interface; and when the first interactive parameter is acquired by detection, the acquisition unit is a sensor.

Specific structures of the first determination unit 120 and the second determination unit 130 may comprise a processor and a storage medium. The storage medium is connected to the processor through a bus, and has executable codes stored thereon. The processor reads and executes the executable codes to implement functions of the first determination unit 120 and the second determination unit 130. The processor may be an electronic component having a processing function such as a Central Processing Unit (CPU), a Micro-Processor (MCU), a Programmable Logic Controller (PLC), or a Digital Signal Processor (DSP) or the like. The judgment unit 130 and the control unit 140 may be integrated to correspond to the same processor, or may also correspond to different processors. When the first determination unit 120 and the second determination unit 130 are integrated to correspond to the same processor, the processor implements the functions of the first determination unit 120 and the second determination unit 130 by using a time division thread or concurrent threads.

In the present embodiment, a specific structure of the loading unit 140 may be a processor, and the loading of the interactive object in the first category may further comprise starting a specified program and executing specified instructions and/or functions.

The display unit 150 comprises a display screen configured to display various information output by the electronic device, such as texts and/or images or the like. The display screen may be a liquid display screen, an Organic Light Emitting Diode (OLED) display screen or the like. The interactive object in the first category may be any combination of texts and images.

In conclusion, the present embodiment provides an electronic device, which provides specific hardware for implementing the method as described in the first method embodiment, and can be used to implement any of the technical solutions in the first method embodiment. The present embodiment can also selectively load and display the interactive object in the first category corresponding to the second electronic device according to the type of the second electronic device, and have advantages such as improved user satisfaction, reduced system consumption, or the like.

### Second Device Embodiment

As shown in FIG. 1, the present embodiment provides an electronic device comprising a display unit 150 capable of displaying at least one interactive object in a first category, wherein the electronic device is a first electronic device, the interactive object in the first category can respond to a first category of operations, and the first electronic device can communicate with a second electronic device. An interactive object of the first category 101 and an interactive object of the first category 102 are shown in FIG. 1.

As shown in FIG. 5, the first electronic device comprises:

an acquisition unit 110 configured to acquire a first interactive parameter;

a first determination unit 120 configured to determine a type of the second electronic device according to the first interactive parameter;

a second determination unit 130 configured to determine, according to the type of the second electronic device, a second interactive parameter matched with an interactive type corresponding to the second electronic device;

a loading unit 140 configured to load, according to the second interactive parameter, the interactive object in the first category; and

the display unit 150 further configured to display the interactive object in the first category.

The second interactive parameter comprises a common interactive parameter and a characteristic interactive parameter, wherein the common interactive parameter is an interactive parameter commonly used in different interactive modes, and the characteristic interactive parameter is an interactive parameter solely used in respective interactive mode;

the first determination unit 110 is configured to determine the characteristic interactive parameter in the second interactive parameter according to the first interactive parameter; and

the second determination unit 120 is configured to load the interactive object in the first category according to the characteristic interactive parameter.

In a specific implementation, the first electronic device comprises a storage medium, which stores second interactive parameters corresponding to various interactive modes. The second interactive parameters are divided into a common interactive parameter and characteristic interactive parameters. The storage medium may be a structure such as a flash or a Read-Only Memory (ROM) or the like. In a specific implementation, the storage medium may be divided into two parts, wherein the first part is used to store the common interactive parameter, and the second part is used to store the characteristic interactive parameters. No matter which interactive mode is used, the common interactive parameter is to be read and operated by the first electronic device, while the characteristic interactive parameters are to be searched and operated in the second part by the first electronic device according to the determined type of the second electronic device. Thus, the characteristic interactive parameters and the common interactive parameter are stored separately, which is beneficial for inquiry and maintenance of the second interactive parameters.

In conclusion, the present embodiment is further defined on the basis of the above device embodiment, which provides specific hardware for implementing the method as described in the second method embodiment, and can be used to implement any of the technical solutions in the second method embodiment. The present embodiment can also selectively load and display the interactive object in the first category corresponding to the second electronic device according to the type of the second electronic device, and have advantages such as improved user satisfaction, reduced system consumption, or the like.

### Third Device Embodiment

As shown in FIG. 1, the present embodiment provides an electronic device comprising a display unit 150 capable of displaying at least one interactive object in a first category, wherein the electronic device is a first electronic device, the interactive object in the first category can respond to a first category of operations, and the first electronic device can communicate with a second electronic device. An interactive object of the first category 101 and an interactive object of the first category 102 are shown in FIG. 1.

As shown in FIG. 5, the first electronic device comprises:

an acquisition unit 110 configured to acquire a first interactive parameter;

a first determination unit 120 configured to determine a type of the second electronic device according to the first interactive parameter;

a second determination unit 130 configured to determine, according to the type of the second electronic device, a second interactive parameter matched with an interactive type corresponding to the second electronic device;

a loading unit 140 configured to load, according to the second interactive parameter, the interactive object in the first category; and

the display unit 150 further configured to display the interactive object in the first category.

The second interactive parameter comprises a common interactive parameter and a characteristic interactive parameter, wherein the common interactive parameter is an interactive parameter commonly used in different interactive modes, and the characteristic interactive parameter is an interactive parameter solely used in respective interactive mode;

the first determination unit 110 is configured to determine the characteristic interactive parameter in the second interactive parameter according to the first interactive parameter; and

the second determination unit 120 is configured to load the interactive object in the first category according to the characteristic interactive parameter.

The characteristic interactive parameter comprises a display parameter; and

the display unit 150 is further configured to display the interactive object in the first category according to the display parameter.

In a specific implementation, the display unit 150 may further be configured to display, according to only the display parameter in the characteristic interactive parameter, the interactive object in the first category, for example, an interactive object in a first category specific to a wireless mouse. The display unit 150 is further configured to display interactive object in a first category according to the display parameters in the characteristic interactive parameter and the common interactive parameter, if some interactive objects in the first category are present in each and every interactive mode with differences in local parameters such as an area and/or a position or the like.

In conclusion, the present embodiment is further defined on the basis of the first device embodiment and the second device embodiment as described above, which provides specific hardware for implementing the method as described in the third method embodiment, and can be used to implement any of the technical solutions in the third method embodiment. The present embodiment can also selectively load and display the interactive object in the first category corresponding to the second electronic device according to the type of the second electronic device, and have advantages such as improved user satisfaction, reduced system consumption, or the like.

### Fourth Device Embodiment

As shown in FIG. 1, the present embodiment provides an electronic device comprising a display unit 150 capable of displaying at least one interactive object in a first category, wherein the electronic device is a first electronic device, the interactive object in the first category can respond to a first category of operations, and the first electronic device can communicate with a second electronic device. An interactive object of the first category 101 and an interactive object of the first category 102 are shown in FIG. 1.

As shown in FIG. 5, the first electronic device comprises:

an acquisition unit 110 configured to acquire a first interactive parameter;

a first determination unit 120 configured to determine a type of the second electronic device according to the first interactive parameter;

a second determination unit 130 configured to determine, according to the type of the second electronic device, a second interactive parameter matched with an interactive type corresponding to the second electronic device;

a loading unit 140 configured to load, according to the second interactive parameter, the interactive object in the first category; and

the display unit 150 further configured to display the interactive object in the first category.

The second interactive parameter comprises a common interactive parameter and a characteristic interactive parameter, wherein the common interactive parameter is an interactive parameter commonly used in different interactive modes, and the characteristic interactive parameter is an interactive parameter solely used in respective interactive mode;

the first determination unit 110 is configured to determine the characteristic interactive parameter in the second interactive parameter according to the first interactive parameter; and

the second determination unit 120 is configured to load the interactive object in the first category according to the characteristic interactive parameter.

the characteristic interactive parameter comprises a response parameter; and

the loading unit 140 is further configured to load response events for the interactive object in the first category according to the response parameter.

In a specific implementation, the loading unit 140 may further configured to load, according to only the response parameter in the characteristic interactive parameter, the interactive object in the first category, for example, an interactive object in a first category specific to a wireless mouse. The loading unit 140 is further configured to load interactive object in a first category according to the response parameters in the characteristic interactive parameter and the common interactive parameter, if the interactive object in the first category is present in each and every interactive mode with differences in the response events in which one or more features are added or deleted.

In conclusion, the present embodiment is further defined on the basis of the first device embodiment to the third device embodiment as described above, which provides specific hardware for implementing the method as described in the fourth method embodiment, and can be used to implement any of the technical solutions in the fourth method embodiment. The present embodiment can also selectively load and display the interactive object in the first category corresponding to the second electronic device according to the type of the second electronic device, and have advantages such as improved user satisfaction, reduced system consumption, or the like.

### Fifth Device Embodiment

As shown in FIG. 1, the present embodiment provides an electronic device comprising a display unit 150 capable of displaying at least one interactive object in a first category, wherein the electronic device is a first electronic device, the interactive object in the first category can respond to a first category of operations, and the first electronic device can communicate with a second electronic device. An interactive object of the first category 101 and an interactive object of the first category 102 are shown in FIG. 1.

As shown in FIG. 5, the first electronic device comprises:

an acquisition unit 110 configured to acquire a first interactive parameter;

a first determination unit 120 configured to determine a type of the second electronic device according to the first interactive parameter;

a second determination unit 130 configured to determine, according to the type of the second electronic device, a second interactive parameter matched with an interactive type corresponding to the second electronic device;

a loading unit 140 configured to load, according to the second interactive parameter, the interactive object in the first category, and

the display unit 150 further configured to display the interactive object in the first category.

The first electronic device comprises at least two types of interactive interfaces, wherein one type of interactive interface can be used to establish a connection to the second electronic device;

the acquisition unit 110 is further configured to detect each interactive interface to form a detection parameter; and

the first determination unit 120 is configured to determine whether a connection is established between the first electronic device and the second electronic device according to the detection parameter, and when the detection parameter indicates that only one interactive interface has been used to establish a connection to the second electronic device, determine the type of the second electronic device according to the type of the interactive interface which has been used to establish a connection to the second electronic device.

The interactive interface may be for example a wired interactive interface such as a USB interface, a Bluetooth interactive interface, an infrared interactive interface, or another type of near-field communication interactive interface, or the like.

Different types of second electronic devices will establish connections to the first electronic device through different interactive interfaces. Specifically, a remote control generally establishes a connection to the first electronic device through an infrared interactive interface, a wired mouse generally establishes a connection to the first electronic device through a wired interface, such as a USB interface, and a wireless mouse generally establishes a connection to the first electronic device through a Bluetooth interactive interface.

In the present embodiment, a specific structure of the acquisition unit 110 may comprise a logic circuit, and may specifically comprise structures such as a sampling circuit and a comparison circuit or the like. The sampling circuit is configured to collect electrical signals of all interactive interfaces, and the comparison circuit is configured to compare the collected electrical signals with the specified electrical signals to acquire a detection parameter. The detection parameter may specifically be a logic level 1 or 0, which represents whether a connection has been established through a corresponding interactive interface. In a specific implementation, the acquisition unit 110 for forming the detection parameter is not limited to the above structure.

The specific structures of the first determination unit 120 and the second determination unit 130 may be known with reference to any of the above device embodiments, and will not be described here.

In conclusion, the present embodiment is further defined on the basis of the first device embodiment to the fourth device embodiment as described above, which provides specific hardware for implementing the method as described in the fifth method embodiment, and can be used to implement any of the technical solutions in the fifth method embodiment. The present embodiment can also selectively load and display the interactive object in the first category corresponding to the second electronic device according to the type of the second electronic device, and have advantages such as improved user satisfaction, reduced system consumption, or the like.

### Sixth Device Embodiment

As shown in FIG. 1, the present embodiment provides an electronic device comprising a display unit 150 capable of displaying at least one interactive object in a first category, wherein the electronic device is a first electronic device, the interactive object in the first category can respond to a first category of operations, and the first electronic device can communicate with a second electronic device. An interactive object of the first category 101 and an interactive object of the first category 102 are shown in FIG. 1.

As shown in FIG. 5, the first electronic device comprises:

an acquisition unit 110 configured to acquire a first interactive parameter;

a first determination unit 120 configured to determine a type of the second electronic device according to the first interactive parameter;

a second determination unit 130 configured to determine, according to the type of the second electronic device, a second interactive parameter matched with an interactive type corresponding to the second electronic device;

a loading unit 140 configured to load, according to the second interactive parameter, the interactive object in the first category; and

the display unit 150 further configured to display the interactive object in the first category.

The acquisition unit 110 is further configured to detect each interactive interface to form a detection parameter; and

the first determination unit 120 is configured to determine whether a connection is established between the first electronic device and the second electronic device according to the detection parameter, and when the detection parameter indicates that only one interactive interface has been used to establish a connection to the second electronic device, determine the type of the second electronic device according to the type of the interactive interface which has been used to establish a connection to the second electronic device.

The first determination unit 120 is further configured to determine the type of the second electronic device according to a selection strategy when the detection parameter indicates that at least two interactive interfaces have been used to establish connections to the second electronic device.

On the basis of the above embodiment, the present embodiment additionally defines how to determine the type of the second electronic device when at least two interactive interfaces have been used to establish connections to the second electronic device. Details of determination of the type of the second electronic device may be known with reference to the corresponding description in the sixth method embodiment, and will not be described in detail here.

The first determination unit 120 according to the present embodiment at least comprises a storage medium, which stores information related to the selection strategy.

In conclusion, the present embodiment is further defined on the basis of the first device embodiment to the fifth device embodiment as described above, which provides specific hardware for implementing the method as described in the sixth method embodiment, and can be used to implement any of the technical solutions in the sixth method embodiment. The present embodiment can also selectively load and display the interactive object in the first category corresponding to the second electronic device according to the type of the second electronic device, and have advantages such as improved user satisfaction, reduced system consumption, or the like.

### Seventh Device Embodiment

As shown in FIG. 1, the present embodiment provides an electronic device comprising a display unit 150 capable of displaying at least one interactive object in a first category, wherein the electronic device is a first electronic device, the interactive object in the first category can respond to a first category of operations, and the first electronic device can communicate with a second electronic device. An interactive object of the first category 101 and an interactive object of the first category 102 are shown in FIG. 1.

As shown in FIG. 5, the first electronic device comprises:

an acquisition unit 110 configured to acquire a first interactive parameter;

a first determination unit 120 configured to determine a type of the second electronic device according to the first interactive parameter;

a second determination unit 130 configured to determine, according to the type of the second electronic device, a second interactive parameter matched with an interactive type corresponding to the second electronic device;

a loading unit 140 configured to load, according to the second interactive parameter, the interactive object in the first category; and

the display unit 150 further configured to display the interactive object in the first category.

The acquisition unit 110 is further configured to detect each interactive interface to form a detection parameter; and

the first determination unit 120 is configured to determine whether a connection is established between the first electronic device and the second electronic device according to the detection parameter, and when the detection parameter indicates that only one interactive interface has been used to establish a connection to the second electronic device, determine the type of the second electronic device according to the type of the interactive interface which has been used to establish a connection to the second electronic device.

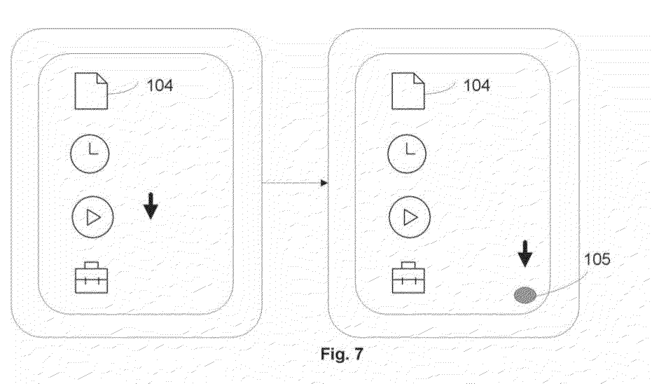

As shown in FIG. 6, the first electronic device is further connected to a sensor unit;

the first determination unit 110 is configured to load and display interactive object in a first category corresponding to an autonomous interactive mode when the detection parameter indicates that none of the interactive interfaces is used to establish a connection to the second electronic device; and

the sensor unit 160 is configured to detect an interactive operation input by a user when the interactive object in the first category corresponding to the autonomous interactive mode is used.

The sensor unit 160 may be a component integrated into the first electronic device, or may also be a component connected to the first electronic device.

The autonomous interactive mode may be an operation such as voice interaction, hover touch and/or eye tracking, or the like. The hover touch is an operation instruction input by a user to the first electronic device through a gesture.

When the autonomous interactive mode is voice interaction, the sensor unit 160 is a voice collection unit, which specifically comprises structures such as a microphone, a database of a voice recognition model, and a voice recognition processor, or the like.

When the autonomous interactive mode is hover touch, the sensor unit 160 may be a structure such as a capacitive screen which can accept hover touch or a camera which can acquire a user's operational gesture or the like.

When the autonomous interactive mode is eye tracking interactive mode, the sensor unit may be a structure such as an eyeball tracker, an eye tracker, or a pupil position and analysis device, or the like.

In a specific implementation, the sensor unit may have different structures according to different autonomous interactive modes, which are not limited to the above structures.

In conclusion, the present embodiment is further defined on the basis of the first device embodiment to the sixth device embodiment as described above, which provides specific hardware for implementing the method as described in the seventh method embodiment, and can be used to implement any of the technical solutions in the seventh method embodiment. The present embodiment can also selectively load and display the interactive object in the first category corresponding to the second electronic device according to the type of the second electronic device, and have advantages such as improved user satisfaction, reduced system consumption, or the like.

### Eighth Device Embodiment

As shown in FIG. 1, the present embodiment provides an electronic device comprising a display unit 150 capable of displaying at least one interactive object in a first category, wherein the electronic device is a first electronic device, the interactive object in the first category can respond to a first category of operations, and the first electronic device can communicate with a second electronic device. An interactive object of the first category 101 and an interactive object of the first category 102 are shown in FIG. 1.

As shown in FIG. 5, the first electronic device comprises:

an acquisition unit 110 configured to acquire a first interactive parameter;

a first determination unit 120 configured to determine a type of the second electronic device according to the first interactive parameter,

a second determination unit 130 configured to determine, according to the type of the second electronic device, a second interactive parameter matched with an interactive type corresponding to the second electronic device;

a loading unit 140 configured to load, according to the second interactive parameter, the interactive object in the first category; and

the display unit 150 further configured to display the interactive object in the first category.

The acquisition unit 110 is further configured to receive a first signal transmitted by the second electronic device; and

the first determination unit 120 is further configured to determine the first interactive parameter according to the type of the first signal or information carried in the first signal.

In the present embodiment, the type of the second electronic device and the second interactive parameter are determined directly according to the first signal interacted between the first electronic device and the second electronic device. A specific structure of the acquisition unit 150 comprises a receiving interface, such as a receiving antenna or the like. A specific structure of the first determination unit 120 may be known with reference to any of the above embodiments, and will not be described here.

In conclusion, the present embodiment is further defined on the basis of the first device embodiment to the seventh device embodiment as described above, which provides specific hardware for implementing the method as described in the eighth method embodiment, and can be used to implement any of the technical solutions in the eighth method embodiment. The present embodiment can also selectively load and display the interactive object in the first category corresponding to the second electronic device according to the type of the second electronic device, and have advantages such as improved user satisfaction, reduced system consumption, or the like.

### Ninth Device Embodiment

As shown in FIG. 1, the present embodiment provides an electronic device comprising a display unit 150 capable of displaying at least one interactive object in a first category, wherein the electronic device is a first electronic device, the interactive object in the first category can respond to a first category of operations, and the first electronic device can communicate with a second electronic device. An interactive object of the first category 101 and an interactive object of the first category 102 are shown in FIG. 1.

As shown in FIG. 5, the first electronic device comprises:

an acquisition unit 110 configured to acquire a first interactive parameter;

a first determination unit 120 configured to determine a type of the second electronic device according to the first interactive parameter;

a second determination unit 130 configured to determine, according to the type of the second electronic device, a second interactive parameter matched with an interactive type corresponding to the second electronic device;

a loading unit 140 configured to load, according to the second interactive parameter, the interactive object in the first category; and

the display unit 150 further configured to display the interactive object in the first category.

The display unit 140 is further configured to display an interactive object in a second category 105, wherein the interactive object in the second category 105 is used to respond to a second category of operations, and the second category of operations are switching operations between the interactive modes; and

the acquisition unit 110 is further configured to receive the second category of operations input by a user through the interactive object in the second category; and to determine the first interactive parameter in response to the second category of operations.

The interactive object in the second category 105 is preferably located in an edge position of the display unit 150, and may generally be in a normal display state. In the normal display state, no matter which interactive state and which interactive page the first electronic device is currently in, the interactive object in the second category will be displayed.

In a specific implementation, the interactive object in the second category may correspond to two states, i.e., a display state and a hidden state. In FIG. 7, the black arrow represents an indicator icon formed by the second electronic device on the first electronic device. Specifically, the indicator icon may be a cursor. The left portion of FIG. 7 is a diagram illustrating the interactive object in the second category being in a hidden state when a distance between the cursor and the interactive object in the second category is greater than a first distance. The right portion of FIG. 7 is a diagram illustrating the interactive object in the second category being in a display state when the distance between the cursor and the interactive object in the second category is less than the first distance. In this manner, the interactive object in the second category in a normal display state can be prevented from interfering with other information displayed on the display unit.

In conclusion, the present embodiment is further defined on the basis of the first device embodiment to the eighth device embodiment, which provides specific hardware for implementing the method as described in the ninth method embodiment, and can be used to implement any of the technical solutions in the ninth method embodiment. The present embodiment can also selectively load and display the interactive object in the first category corresponding to the second electronic device according to the type of the second electronic device, and have advantages such as improved user satisfaction, reduced system consumption or the like.

It should be understood that the devices and methods disclosed in the embodiments of the present disclosure may be implemented in other manners.

The device embodiments as described above are merely illustrative. For example, the division of the units is merely a logically functional division, and in practice, there may be other division manners. For example, multiple units or components may be combined or may be integrated into another system, or some features may be ignored or may not be implemented. In addition, various constituent parts, which are displayed or discussed as being coupled or communicatively connected directly, may also be coupled or communicatively connected indirectly via some interfaces, devices or units in an electrical manner, a mechanical manner, or other manners.

The above units described as separate components may be or may not be separated physically. The components displayed as units may be or may not be physical units, i.e., they may be located in a place or may also be distributed among multiple network units. A part or all of the units may be selected as needed to achieve the purpose of the solutions of the present disclosure.

In addition, various functional units according to the embodiments of the present disclosure may all be integrated into a processing module, or various units may be used separately, or two or more units are integrated into a unit. The above integrated units may be implemented by hardware or by hardware and software functional units.

A person having ordinary skill in the art can understand that all or a part of steps for implementing the above method embodiments may be implemented by programs instructing related hardware. The programs may be stored in a computer readable storage medium. When the programs are executed, the steps of the above method embodiments are implemented. The storage medium may be a medium which can store program codes, such as a mobile storage device, a Read-Only Memory (ROM), a Random Access Memory (RAM), a disk, or a disc etc.

The above description is merely specific embodiments of the present disclosure, and the scope of the present disclosure is not limited thereto. Changes or substitutions, which can be obviously envisaged by those skilled persons in the art, should be included in the scope of the present disclosure without departing the scope defined by the appended claims.

I/we claim:

1. An information processing method, the method comprising:
a first electronic device acquiring a first interactive parameter from a second electronic device;
the first electronic device determining a type of the second electronic device according to the first interactive parameter;
the first electronic device determining, according to the type of the second electronic device, a second interactive parameter corresponding to the second electronic device; and
the first electronic device displaying at least one interactive object, according to the second interactive parameter, via a display unit of the first electronic device.

2. The method according to claim 1, wherein
the second interactive parameter comprises a common interactive parameter and a characteristic interactive parameter, wherein the common interactive parameter is an interactive parameter commonly used in different interactive modes, and the characteristic interactive parameter is an interactive parameter solely used in respective interactive mode; and
the determining of a second interactive parameter according to the first interactive parameter comprises:
determining the characteristic interactive parameter in the second interactive parameter according to the first interactive parameter; whereas the displaying of the interactive object according to the second interactive parameter comprises:
displaying the interactive object according to the characteristic interactive parameter.

3. The method according to claim 2, wherein
the characteristic interactive parameter comprises a display parameter; and
the displaying of the interactive object according to the second interactive parameter comprises:
displaying the interactive object according to the display parameter.

4. The method according to claim 2, wherein
the characteristic interactive parameter comprises a response parameter; and
the displaying of the interactive object according to the second interactive parameter comprises:
loading a response event for the interactive object according to the response parameter.

5. The method according to claim 1, wherein
the first electronic device comprises at least two types of interactive interfaces, wherein each type of interactive interfaces can be used to establish a connection with a corresponding type of second electronic devices; and
the acquiring of the first interactive parameter comprises:
detecting each type of interactive interfaces to form a detection parameter; and
the determining of a type of the second electronic device according to the first interactive parameter comprises:
if the detection parameter indicates that only one type of interactive interfaces has been used to establish a connection to the second electronic device,
determining the type of the second electronic device according to the type of the interactive interface which has been used to establish a connection to the second electronic device.

6. The method according to claim 5, wherein
the determining of a type of the second electronic device according to the first interactive parameter further comprises:
determining the type of the second electronic device according to a selection strategy if the detection parameter indicates that at least two types of interactive interfaces have been used to establish connections to the second electronic device.

7. The method according to claim 5, wherein
the first electronic device is further connected to a sensor unit; and
the method further comprises:
displaying the interactive object corresponding to an autonomous interactive mode if the detection parameter indicates that none of the interactive interfaces is used to establish a connection to the second electronic device; and
detecting, by the first electronic device, an interactive operation input by a user through the sensor unit if the interactive object corresponding to the autonomous interactive mode is used.

8. The method according to claim 1, wherein
the first electronic device acquiring the first interactive parameter comprises:
the first electronic device receiving a first signal transmitted by the second electronic device; and
the first electronic device determining the type of the second electronic device according to the first interactive parameter comprises:
determining the first interactive parameter according to the first signal.

9. The method according to claim 1, wherein
the display unit of the first electronic device is further configured to display an interactive object different categories, wherein the interactive object in a particular category is used to respond to a corresponding category of operations; and
the first electronic device acquiring the first interactive parameter further comprises:
receiving a different category of operations input by a user through the interactive object in a different category; and
determining the first interactive parameter in response to the different category of operations.

10. An electronic device, comprising:
a display unit capable of displaying at least one interactive object; and
a processor configured:
to acquire a first interactive parameter from a second electronic device;
to determine a type of the second electronic device according to the first interactive parameter;
to determine, according to the type of the second electronic device, a second interactive parameter corresponding to the second electronic device; and
to display the interactive object via the display unit.

11. The electronic device according to claim 10, wherein
the second interactive parameter comprises a common interactive parameter and a characteristic interactive parameter, wherein the common interactive parameter is an interactive parameter commonly used in different interactive modes, and the characteristic interactive parameter is an interactive parameter solely used in respective interactive mode; and
the processor is configured:
to determine the characteristic interactive parameter in the second interactive parameter according to the first interactive parameter; and
to display the interactive object according to the characteristic interactive parameter.

12. The electronic device according to claim 11, wherein
the characteristic interactive parameter comprises a display parameter; and
the display unit is further configured to display the interactive object according to the display parameter.

13. The electronic device according to claim 11, wherein
the characteristic interactive parameter comprises a response parameter; and
the processor is further configured to load a response event for the interactive object according to the response parameter.

14. The electronic device according to claim 10, wherein
the first electronic device comprises at least two types of interactive interfaces, wherein each type of interactive interfaces can be used to establish a connection to a corresponding type of second electronic devices; and
the processor is further configured:
to detect each type of interactive interfaces to form a detection parameter, and
to determine whether a connection is established between the first electronic device and the second electronic device according to the detection parameter, and configured to, if the detection parameter indicates that only one type of interactive interfaces has been used to establish a connection to the second electronic device, determine the type of the second electronic device according to the type of the interactive interface which has been used to establish a connection to the second electronic device.

15. The electronic device according to claim 14, wherein
the processor is further configured to determine the type of the second electronic device according to a selection strategy when the detection parameter indicates that at least two types of interactive interfaces have been used to establish connections to the second electronic device.

16. The electronic device according to claim 14, wherein
the first electronic device is further connected to a sensor unit;
the processor is configured to display the interactive object corresponding to an autonomous interactive mode if the detection parameter indicates that none of the interactive interfaces is used to establish a connection to the second electronic device; and
the sensor unit is configured to detect an interactive operation input by a user if the interactive object corresponding to the autonomous interactive mode is used.

17. The electronic device according to claim 10, wherein
the processor is further configured:
to receive a first signal transmitted by the second electronic device; and
to determine the first interactive parameter according to the first signal.

18. The electronic device according to claim 10, wherein
the display unit is further configured to display an interactive object in different categories, wherein the interactive object in a different category is used to respond to a different category of operations; and
the processor is further configured to receive a different category of operations input by a user through a different category of interactive operations; and to determine the first interactive parameter in response to the different category of operations.
